(19) United States
(12) Patent Application Publication
(10) Pub. No.: US 2017/0316533 A1
(43) Pub. Date: Nov. 2, 2017

(54) PERSONAL SAFETY AND PRIVACY FEATURES FOR PASSENGERS OF AN AUTONOMOUS VEHICLE BASED TRANSPORTATION SYSTEM

(71) Applicant: GM GLOBAL TECHNOLOGY OPERATIONS LLC, Detroit, MI (US)

(72) Inventors: CLAUDIA V. GOLDMAN-SHENHAR, MEVASSERET ZION (IL); GILA KAMHI, ZICHRON YAAKOV (IL)

(73) Assignee: GM GLOBAL TECHNOLOGY OPERATIONS LLC, Detroit, MI (US)

(21) Appl. No.: 15/491,756

(22) Filed: Apr. 19, 2017

Related U.S. Application Data
(63) Continuation of application No. 15/484,561, filed on Apr. 11, 2017, now abandoned.
(60) Provisional application No. 62/329,472, filed on Apr. 29, 2016.

(51) Int. Cl. G06Q 50/30; G07C 9/00; G08G 1/00

(52) U.S. Cl. CPC G06Q 50/30; G08G 1/202; G07C 9/00134; G06Q 2240/00

(57) ABSTRACT

Computer-based systems and related operating methods for an autonomous vehicle transportation system are presented here. Various features, functions, and methodologies are utilized by the transportation system to enhance personal safety and security for passengers. Security, privacy, and safety features can be provided based on a ride reservation type, the identity or user profiles of passengers, and the like. A security alert feature can also be provided onboard the autonomous vehicles.

### CROSS-REFERENCE TO RELATED APPLICATIONS

This application is a continuation of U.S. patent application Ser. No. 15/484,561, filed Apr. 11, 2017, which claims the benefit of U.S. provisional patent application No. 62/329,472, filed Apr. 29, 2016.

### TECHNICAL FIELD

Embodiments of the subject matter described herein relate generally to transportation systems. More particularly, embodiments of the subject matter relate to enhanced features suitable for use in an autonomous vehicle transportation system that supports shared rides (multiple passengers in one autonomous vehicle).

BACKGROUND

Driverless vehicles have been under development for several years. An autonomous vehicle uses onboard sensor systems, global positioning system (GPS) technology, navigation systems, and drive-by-wire systems to transport passengers on roads that may be occupied by traditional vehicles and/or other autonomous vehicles.

It is desirable to have enhanced features, operating methods, and functions in an autonomous vehicle transportation system. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified block diagram that illustrates an autonomous vehicle based transportation system and related systems and subsystems;

FIG. 2 is a block diagram of an exemplary embodiment of a processor-based hardware platform suitable for use in various system components described herein;

FIG. 3 is a schematic representation of an exemplary embodiment of a ride reservation interface suitable for use with a vehicle based transportation system; and

FIG. 4 is a schematic representation of an exemplary embodiment of an emergency assistance interface suitable for use with a vehicle based transportation system.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

For the sake of brevity, conventional techniques related to the control and operation of autonomous (i.e., driverless or self-driving) vehicles, mobile client devices, navigation and mapping systems, the global positioning system (GPS), security and access control systems, social media applications, signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter described herein relates to an autonomous vehicle based transportation system having at least one driverless vehicle that is automatically controlled to carry passengers from one location to another. The exemplary embodiments can be deployed in a taxi or shuttle system that services a geographical area. The disclosed subject matter provides certain enhanced features and functionality to what may be considered as a standard or baseline autonomous vehicle system. To this end, an autonomous vehicle based transportation system can be modified, enhanced, or otherwise supplemented to provide the additional features mentioned in more detail below.

In accordance with the embodiments described below, the system supports various features, functions, and methodologies that are intended to increase the personal safety, psychological comfort, and privacy of passengers, especially in the context of a shared vehicle scenario where passengers may be strangers to one another. The features described in more detail herein address the personal safety and psychological comfort level of passengers in an autonomous vehicle transportation system, starting from the ride reservation stage, through the process of being picked up by an autonomous vehicle, during the driverless ride to the intended destination, and after completion of the ride.

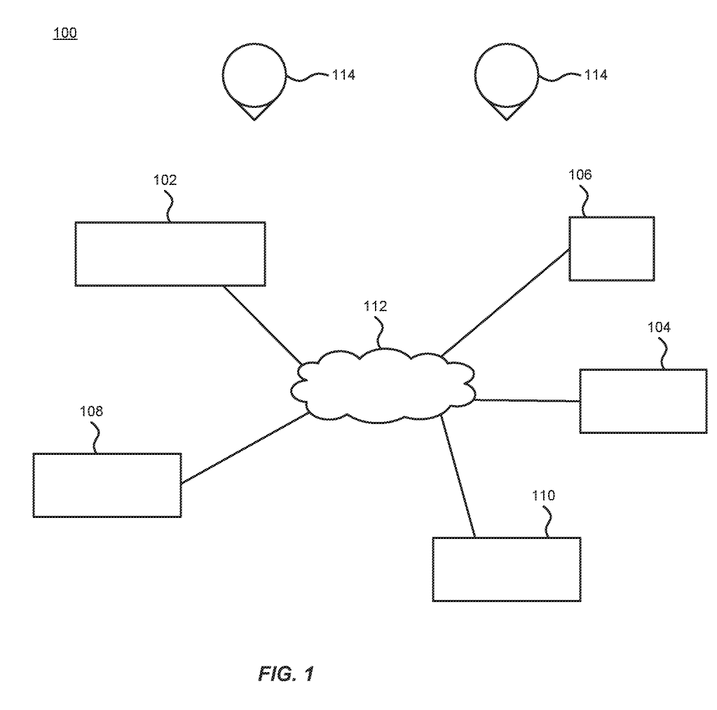

FIG. 1 is a simplified block diagram of an exemplary embodiment of an operating environment 100 that includes an autonomous vehicle transportation system 102 and related systems and subsystems. The techniques and methodologies described with reference to the operating environment 100 can also be implemented in the context of other system architectures and environments. The operating environment 100 described here represents one practical scenario that can benefit from certain enhanced features. The illustrated embodiment of the operating environment 100 includes, without limitation: the transportation system 102; at least one autonomous vehicle 104 controlled by the transportation system 102; at least one user device 106; a security and access system 108; a navigation and map system 110; and a communication network 112. Certain devices or systems in the operating environment 100 can communicate with global positioning system (GPS) satellites 114, only two of which are depicted in FIG. 1. The devices, systems, and components supported by the operating environment 100 can communicate with one another (via tangible communication links and/or wireless communication links) as needed via the communication network 112.

Although only one user device 106 is shown in FIG. 1, an embodiment of the operating environment 100 can support any number of user devices 106, including multiple user devices 106 owned, operated, carried, worn, or otherwise used by one person. Each user device 106 supported by the operating environment 100 may be implemented using any suitable hardware platform. In this regard, a user device 106 can be realized in any common form factor including, without limitation: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 106 supported by the operating environment 100 is realized as a computer-implemented or computer-based device having the hardware, software, firmware, and/or processing logic needed to carry out the various techniques and methodologies described in more detail herein.

The autonomous vehicle transportation system 102 includes or cooperates with one or more driverless vehicles (the autonomous vehicles 104). Accordingly, the system 102 can include or cooperate with the necessary onboard native processing, control, and computing intelligence and logic of the autonomous vehicles 104. The system 102 may also include one or more backend server systems, which may be cloud-based, network-based, or resident at the particular campus or geographical location serviced by the system 102. The system 102 can communicate with the user devices 106 operated by passengers to schedule rides, dispatch vehicles, and the like. In addition, the system 102 can communicate with the security and access system 108, the navigation and map system 110, and/or other compatible systems (not shown in FIG. 1) as needed

The operating environment 100 can include any number of predefined vehicle pickup/drop-off locations (waypoint stops) that are known to the transportation system 102. Alternatively or additionally, the transportation system 102 can leverage GPS technology (and/or other position or location determination techniques or methodologies) to pick up passengers at any location and/or to leave passengers at any desired destination location. In accordance with a typical use case scenario, a registered user of the transportation system 102 can create a ride request or reservation via the user device 106 or using any other communication service, system, or device that is compatible with the service provider of the transportation system. The ride request will typically include a username or user identifier for the passenger, and indicate the passenger's desired pickup location (or current GPS location), the desired destination location (which may identify a predefined vehicle stop and/or a user-specified passenger destination), and a desired pickup time. In some situations, the actual pickup location can be recognized or determined automatically by the system 102, or it might be known from historical data collected for the requesting user. Moreover, there can be more than one destination point or location conveyed in the ride request, such as a final destination point with one or more waypoint locations specified along the route.

The transportation system 102 receives the ride request, processes the request, and dispatches an autonomous vehicle (when and if one is available) to pick up the passenger at the designated pickup location and at the appropriate time. The transportation system 102 can also generate and send a suitably configured confirmation message or notification to the passenger, to let the passenger know that a vehicle is on the way. Any vehicle in the transportation system 102 can be suitably configured to support the various personal safety and privacy protection features described herein.

The security and access system 108 can be an independent and distinct subsystem, or it can be integrated with the transportation system 102 and/or any of the other systems described herein. The security and access system 108 may be implemented with one or more backend server systems, which may be cloud-based, network-based, or resident at the particular campus or geographical location serviced by the transportation system 102. The security and access system 108 is responsible for performing or supporting the various personal safety, security, and protection features described in more detail herein. For example, the security and access system 108 can grant/deny passenger access to the autonomous vehicles 104 as needed. In certain embodiments, the security and access system 108 includes or cooperates with suitably configured security components, applications, or devices onboard the autonomous vehicles 104 and/or onboard the user devices 106. For example, the security and access system 108 can utilize any of the following, without limitation: security badges or cards; RFID tags; fingerprint scanners; bar code readers; biometric scanners; keypads; wireless communication protocols; or the like. In certain embodiments, the autonomous vehicles 104 controlled by the transportation system 102 includes compatible onboard security and access hardware that can be used to verify the identity of the passengers. The security and access system 108 can also be utilized to grant access rights to locked delivery compartments onboard the autonomous vehicles 104 if so desired.

The navigation and map system 110 can be an independent and distinct subsystem, or it can be integrated with the transportation system 102 and/or any of the other systems described herein. The navigation and map system 110 may be implemented with one or more backend server systems, which may be cloud-based, network-based, or resident at the particular campus or geographical location serviced by the transportation system 102. In some embodiments, the navigation and map system 110 includes or cooperates with compatible features, functions, or applications resident at the autonomous vehicles and/or resident at the user devices 106. For example, a user device 106 may include a locally installed navigation or mapping app that receives and processes data provided by the navigation and map system 110, and that processes GPS signals received from the GPS satellites 114. In this regard, the user device 106 may leverage cached map data, or it may rely on map data provided via the communication network 112. As explained in more detail below, the navigation and map system 110 can be used to determine the passenger transportation routes to be followed by each actively operating autonomous vehicle in the operating environment 100.

The communication network 112 provides and supports data connectivity between the various components and systems in the operating environment 100. In practice, the communication network 112 may be any digital or other communications network capable of transmitting messages or data between devices, systems, or components. In certain embodiments, the communication network 112 includes a packet switched network that facilitates packet-based data communication, addressing, and data routing. The packet switched network could be, for example, a wide area network, the Internet, or the like. In various embodiments, the communication network 112 includes any number of public or private data connections, links or network connections supporting any number of communications protocols. The communication network 112 may include the Internet, for example, or any other network based upon TCP/IP or other conventional protocols. In various embodiments, the communication network 112 could also incorporate a wireless and/or wired telephone network, such as a cellular communications network for communicating with mobile phones, personal digital assistants, and/or the like. The communication network 112 may also incorporate any sort of wireless or wired local and/or personal area networks, such as one or more IEEE 802.3, IEEE 802.16, and/or IEEE 802.11 networks (Wi-Fi), a dedicated short range communication (DSRC) network, and/or networks that implement a short range (e.g., Bluetooth) protocol.

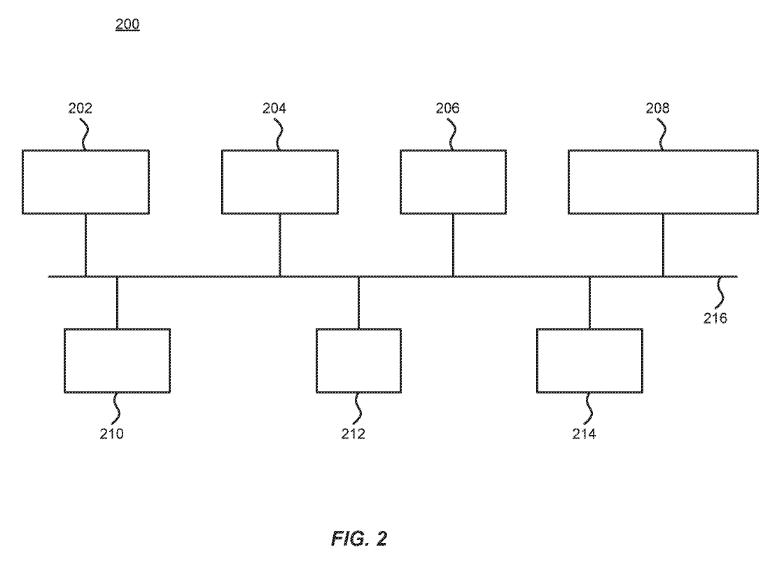

The various systems, devices, and components in the operating environment 100 may include or cooperate with computer-based or processor-based hardware. In this regard, FIG. 2 is a block diagram of an exemplary embodiment of a hardware platform 200 suitable for use in the operating environment 100. More specifically, at least one instantiation of the hardware platform 200 (or something similar) can be utilized with each of the elements depicted in FIG. 1. Moreover, at least one instantiation of the hardware platform 200 (or something similar) can be deployed in each of the autonomous vehicles 104. The hardware platform 200 is implemented as a processor-based or computer-based device, system, or component that is designed, configured, and programmed to meet the needs of the particular system or subsystem.

The illustrated embodiment of the hardware platform 200 includes, without limitation: a processor architecture 202 having at least one processor device; a suitable amount of memory 204, which includes at least one computer/processor readable media element; a data storage apparatus 206; device-specific hardware, software, firmware, and/or features 208; a user interface 210; a communication module 212; and a display element 214. Of course, the hardware platform 200 may include additional elements, components, modules, and functionality configured to support various features that are unrelated to the subject matter described here. For example, the hardware platform 200 may include certain features and elements to support conventional functions that might be related to the particular implementation and deployment of the hardware platform 200. In practice, the elements of the hardware platform 200 may be coupled together via a bus or any suitable interconnection architecture 218.

The processor architecture 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. Moreover, the processor architecture 202 may be implemented as a combination of computing devices, e.g., a combination of a digital signal processor and a microprocessor, a plurality of microprocessors, one or more microprocessors in conjunction with a digital signal processor core, or any other such configuration.

The memory 204 may be realized as RAM memory, flash memory, EPROM memory, EEPROM memory, registers, a hard disk, a removable disk, a CD-ROM, or any other form of storage medium known in the art. In this regard, the memory 204 can be coupled to the processor architecture 202 such that the processor architecture 202 can read information from, and write information to, the memory 204. In the alternative, the memory 204 may be integral to the processor architecture 202. As an example, the processor architecture 202 and the memory 204 may reside in an ASIC. At least a portion of the memory 204 can be realized as a computer storage medium, e.g., a tangible computer readable media element having non-transitory processor-executable instructions stored thereon. The computer-executable instructions can be configurable such that, when read and executed by the processor architecture 202, cause the hardware platform 200 to perform certain tasks, operations, functions, and processes described in more detail herein. In this regard, the memory 204 may represent one suitable implementation of such computer-readable media. Alternatively or additionally, the hardware platform 200 could receive and cooperate with computer-readable media (not separately shown) that is realized as a portable or mobile component or platform, e.g., a portable hard drive, a USB flash drive, an optical disc, or the like.

The data storage apparatus 206 can be realized with the memory 204, or it can be implemented as a physically distinct component. The data storage apparatus 206 employs a nonvolatile storage technology to save and maintain data as needed. For example, the data storage apparatus 206 can include flash memory and/or a hard disk formatted to save data that is generated and used by the corresponding host system. The data storage apparatus 206 can be controlled in an appropriate manner to maintain and update one or more databases as needed to support the features described in more detail herein. For example, a database resident onboard the autonomous vehicle 104, onboard the user device 106, or resident at a cloud-based server system can be used to store user profile data for the registered users of the system 102.

The device-specific hardware, software, firmware, and features 208 may vary from one embodiment of the hardware platform 200 to another. For example, the device-specific hardware, software, firmware, and features 208 will support telephone functions and features when the hardware platform 200 is realized as a mobile telephone, conventional personal computer functions and features if hardware platform 200 is realized as a laptop or tablet computer, etc. For the exemplary embodiments described here, the autonomous vehicles 104 and the user devices 106 can include GPS receivers and/or other location determining hardware and functionality integrated therein. Thus, the vehicles 104 and/or the user devices 106 can communicate with the GPS satellites 114 and process geographical position information to calculate their current geographical positions. In practice, certain portions or aspects of the device-specific hardware, software, firmware, and features 208 may be implemented in one or more of the other blocks depicted in FIG. 2.

The user interface 210 may include or cooperate with various features to allow a user to interact with the hardware platform 200. Accordingly, the user interface 210 may include various human-to-machine interfaces, e.g., a keypad, keys, a keyboard, buttons, switches, knobs, a touchpad, a joystick, a pointing device, a virtual writing tablet, a touch screen, a microphone, a camera, or any device, component, or function that enables the user to select options, input information, or otherwise control the operation of the hardware platform 200. The user interface 210 may include one or more graphical user interface (GUI) control elements that enable a user to manipulate or otherwise interact with an application via the display element 214. Moreover, the user interface 210 may support gesture recognition, speech recognition, and/or other human-to-machine input modalities.

The communication module 212 facilitates data communication between the hardware platform 200 and other components as needed during the operation of the hardware platform 200. Referring again to FIG. 1, the communication module 212 (of the user device 106) enables the user device 106 to communicate with the transportation system 102, the security and access system 108, the navigation and map system 110, and/or the autonomous vehicles 104 as needed. Similarly, the communication module 212 (of the security and access system 108) enables the security and access system 108 to communicate with the transportation system 102, the autonomous vehicles 104, and/or the user devices 106 as needed. In practice, an embodiment of the hardware platform 200 may support wireless data communication and/or wired data communication, using various data communication protocols. For example, the communication module 212 could support one or more wireless data communication protocols, techniques, or methodologies, including, without limitation: RF; IrDA (infrared); Bluetooth; ZigBee (and other variants of the IEEE 802.15protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. Moreover, the communication module 212 could support one or more wired/cabled data communication protocols, including, without limitation: Ethernet; home network communication protocols; USB; IEEE 1394 (Firewire); hospital network communication protocols; and proprietary data communication protocols.

The display element 214 is suitably configured to enable the hardware platform 200 to render and display various screens, GUIs, GUI control elements, drop down menus, auto-fill fields, text entry fields, message fields, or the like. Of course, the display element 214 may also be utilized for the display of other information during the operation of the hardware platform 200, as is well understood. Notably, the specific configuration, operating characteristics, size, resolution, and functionality of the display element 214 can vary depending upon the practical implementation of the hardware platform 200. For example, if the hardware platform 200 is a laptop computer, then the display element 214 may be a relatively large monitor. Alternatively, if the hardware platform 200 is a cellular telephone device, then the display element 214 may be a relatively small integrated display screen, which may be realized as a touch screen.

The autonomous vehicle transportation system 102 described here can be suitably configured to provide enhanced passenger security, safety, and privacy features. A number of these features are described below with reference to certain exemplary embodiments. An implementation of the system 102 can leverage any or all of the features and functionality described herein, depending on the particular implementation of the operating environment 100.

User Profiles and Related Security Measures

The examples that follow assume that the system 102 maintains a list of registered users, and that each registered user can be uniquely identified in some manner (e.g., by username and password, a personal identification code, biometric data, or the like, which can be provided by a personal device, a wearable device or item, a smart device or item, a mobile device, a camera, or any suitably configured electronic device). Moreover, the system 102 can maintain a user profile for each registered user, wherein the user profile data can include any or all of the following information, without limitation: legal name; home address; passenger rating data; favorite pickup addresses; favorite destination addresses; phone number; email address; gender; occupation; social group memberships; music preferences; climate control preferences for vehicle cabin; smoking or non-smoking preference; user profile privacy (sharing) preferences; nationality; ethnicity; religion; education level; age; personality traits; hobbies; credit card account and/or other payment modes; emergency contact numbers; music preferences; preferred volume levels; favorite topics to discuss during shared rides; whether or not the user carries objects while riding and, if so, what type of objects; special needs or requirements, such as a larger seat, open windows, medical equipment, baby/child seats, favorite beverages, etc. The user profile data for a given user can be stored in a cloud-based server maintained by the system 102, at one or more of the autonomous vehicles 104, at the user device(s) 106 associated with the user, or the like.

The system 102 allows each registered user to configure user profile sharing/privacy settings. The sharing/privacy setting can be applied to the entire user profile (one setting governs all user profile data), or to groups of user profile items. Alternatively, the sharing/privacy setting can be applied to any number of individual user profile items. For example, a given user can keep some profile data strictly private while allowing other profile data to be publicly viewable.

Users can choose driverless rides that accommodate or allow different sharing/privacy levels. This allows users to control who they ride with and what profile information can be shared. For example, the sharing/privacy setting may range from “Public” where user profile data is freely shared, to “Private” where little to no user profile data is shared. A “Social” level can be used to share some information, such as non-sensitive and non-confidential information, and a “Friends” level can be used to selectively share profile information with other users that have been designated or selected by the passenger. This allows each passenger to control who they share information with by inviting known riders or by asking for a private ride. Moreover, different types of rides can be priced differently, and the system 102 allows each user to reserve a specific type of ride that fits within a given budget. For example, a private ride with only one person can be priced at a premium rate, while a public ride that stops frequently to pick up and drop off multiple passengers can be priced at a more economical rate.

In practice, the sharing/privacy settings for a passenger can influence the type of driverless rides available to that particular passenger. For example, if a passenger's user profile is set to “Private”, then that passenger may not be eligible to participate in rides that require access to profile data, such as rides that are categorized as social rides. On the other hand, if a passenger's user profile is set to “Public”, then that passenger can reserve private rides, public rides, or social rides. The system 102 can be suitably configured to generate a notification or reminder when a user attempts to make a reservation that conflicts in some manner with the user's sharing/privacy settings. For example, assume that the user's sharing/privacy options are mostly set to “Private.” If that user requests a public ride or a social ride that requires access to user profile data, then the system 102 can generate a notification to inform the user of the conflict. The notification can include instructions to resolve the conflict. For this particular example, the notification can instruct the user to change the sharing/privacy setting on certain user profile items. If the user follows the instructions, then he or she will be eligible to participate in the type of ride that was originally requested.

Reservations And Different Ride Types

Different security and passenger safety measures can be employed, depending on the type of ride that is requested. Although not always required, the described embodiments of the system 102 support at least the following ride types: solo (private); public; by invitation; social; and social friends. It should be appreciated that an alternative embodiment of the system 102 can support more or less ride types, or different ride types than those specified here. When making a reservation or requesting a ride, the user can identify or select the ride type (or leave the ride type unspecified if so desired). The system 102 receives and processes ride requests, which can include a ride type designation selected from the available ride types supported by the system 102. The system 102 responds to the selected ride type designation by implementing and providing certain passenger security, passenger safety, vehicle management, and/or passenger privacy features for the requested ride, wherein the provided features are determined or influenced by the selected ride type designation. In this regard, the provided features can include at least one feature associated with control of the vehicle 104 that is dispatched to service the ride request. As another example, the provided features can include at least one feature associated with passenger screening for a shared ride. Such passenger screening may involve accessing and processing user profile information for potential passengers to determine whether or not those passengers are appropriate for ride sharing with the requesting passenger. In certain embodiments, the provided features include at least one feature associated with user profile sharing/privacy settings. For example, the system 102 can review and process user profile settings, make temporary changes, or schedule shared rides based on the sharing/privacy settings of the requesting passenger and/or potential ride sharing passengers.

The different ride types and their corresponding security and safety implications are described in detail below.

“Solo”—Only one passenger (the requesting user) per vehicle; this is a personal and private ride for one user. No other passengers are allowed to enter the driverless vehicle after the requesting user has been verified and enters the vehicle. The system 102 can take appropriate security/safety measures to ensure that the autonomous vehicle 104 remains private and secure. For example, the system 102 can designate the route as “non-stop” to the stated destination and keep all doors locked in transit. Unless there is an emergency vehicle on the road or some other unexpected or compelling reason to stop the vehicle 104, the requesting passenger can rest assured that the vehicle 104 will directly and safely drive to the destination without picking up other passengers. Moreover, the system 102 can have safeguarding or backup measures in place to warn the passenger and/or a system operator if the vehicle 104 makes an unexpected stop, if the doors are unlocked prematurely, if the vehicle 104 traverses an unusual path to the destination, or the like. As another example, the vehicle 104 may need to stop if there is a technical problem, lack of fuel, or limited energy. Accordingly, a safety measure could be to send notifications to the service provider to initiate a request for another vehicle to host the passenger (transfer the passenger to another autonomous vehicle 104). In such a scenario, the passenger can be notified of the problem and the solution. In addition, the system 102 can support a “passenger distress” feature that allows passengers to indicate a problem, a potential safety issue, or the like. This feature is described in more detail below.

“Public”—Any number of passengers (limited by the passenger capacity of the vehicle 104) can be picked up and dropped off as the vehicle 104 is controlled along its route. Any registered user of the system 102 can request a public ride, regardless of that person's user profile sharing/privacy settings. In this regard, an autonomous vehicle 104 functioning as a public ride is akin to a mode of public transportation such as a bus line, a subway, or a shuttle having the freedom to drive any desired route. A user can reserve or request a public ride by providing a pickup location and a destination location. Moreover, a reservation for a public ride can indicate the user's “allowance” or “tolerance” (in terms of distance and/or travel time) for re-routing to accommodate other passengers. For example, the shortest or quickest route to a destination can serve as a reference, and the requesting user can indicate that she is willing to add up to 30 minutes of travel time to accommodate other passengers. In certain embodiments, the price for a public ride decreases in accordance with the number of additional passengers, the predicted or actual travel time to the destination, the predicted or actual mileage to the destination, or the like. The system 102 can take appropriate security/safety measures when a user reserves a public ride. For example, the user can be guaranteed that his profile will not be shared in a public ride. As another example, the system 102 can generate appropriate announcements or notifications during a public ride, wherein the announcements or notifications can be provided inside the vehicle 104, on a user device, and/or on a shared device located onboard the vehicle 104. In this regard, a notification can announce an approaching stop, and identify the new passengers or exiting passengers (if the profile information is available). In addition, the system 102 can support a “passenger distress” feature that allows passengers to indicate a problem, a potential safety issue, or the like. This feature is described in more detail below.

“By Invitation”—For this type of ride, the requesting user can select other riders from her contact list (which may be the native contacts app on the user's phone or a contacts list integrated with a specialized app that can be used to request rides) and invite the selected users to join her as a passenger. Invited passengers can enter the autonomous vehicle 104 at the same pickup location or at different locations within the serviced area. The invited passengers may have the same destination location or different destinations throughout the serviced area. This type of ride increases passenger safety by restricting ride sharing passengers to the limited list of invitees. The system 102 can take additional security/safety measures when a user reserves or participates in this type of ride. For example, the system 102 can require that all invited passengers share their user profiles and user identifier details with the requesting user. The system 102 can also require that all invited passengers share their user profiles and user identifier details with each other, to the extent allowed by their user profile sharing/privacy settings. Alternatively, the system 102 can be configured to not share any user profile information among the invited passengers (unless explicitly allowed by the user). As another example, all invitees might share their social profiles with the person that invited them, but they might not share their profiles among themselves unless explicitly granted or allowed. In addition, the system 102 can support a “passenger distress” feature that allows passengers to indicate a problem, a potential safety issue, or the like. This feature is described in more detail below.

“Social”—When reserving this type of ride, the requesting passenger can indicate her willingness to share a ride based on social factors, which can be found in the public user profiles of other potential passengers. Accordingly, the requesting passenger can make the ride available to people with common interests, to people of the same gender, to people within the same age group, to people who are baseball fans, etc. (whether or not the requesting passenger actually knows the other people). The system 102 can allow the requesting passenger to make selections to narrow or filter the population of available passengers; selections can be made by a dropdown menu, a checklist, a text entry box, voice commands, or the like. Accordingly, a requesting passenger can make her social ride available to other registered users who satisfy her stated criteria (for example, people who are 30 to 40 years old, college educated, politically conservative, and enjoy dogs). In certain embodiments, the other passengers that meet the social ride sharing criteria designated by the requesting user must have at least some of their user profile information publicly shared (or at least shared with the requesting user) to accommodate the creation of a social ride. In other embodiments, social rides can be supported without sharing any profile information, as long as the service provider or the system 102 itself has access to the profile information for purposes of “screening” the eligible passengers. In some implementations, riders are allowed to “filter” or otherwise select the users they would like to share a ride with, based on profile information, preferences, and other information that might be contained in the user profiles. Some profile information can always remain private, such as contact information, names, user identifiers, and the like. The system 102 can take other appropriate security/safety measures when a user reserves a social ride. For example, the system 102 may support a passenger rating system that allows passengers to review other passengers (this feature is described in more detail below). In addition, the system 102 can support a “passenger distress” feature that allows passengers to indicate a problem, a potential safety issue, or the like. This feature is also described in more detail below.

“Social Friends”—This type of ride is similar to a social ride, however, the profile information (including contact details) of all passengers is shared among the entire group of passengers. Thus, the system 102 can make a social friends ride available only to potential passengers who have publicly accessible user profiles, or are willing to temporarily share their user profile and contact information. The system 102 can take other appropriate security/safety measures when a user reserves a social friends ride. For example, riders can have emergency contacts that are linked to their social friends. In addition, the system 102 can support a “passenger distress” feature that allows passengers to indicate a problem, a potential safety issue, or the like. This feature is described in more detail below.

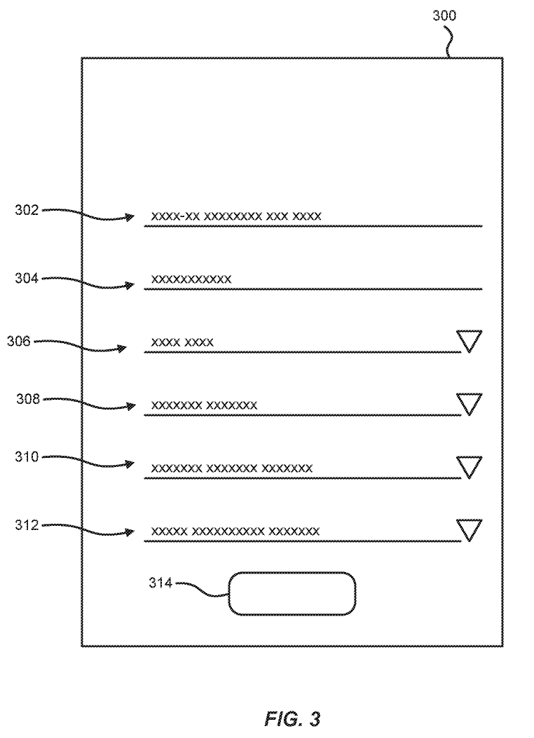

FIG. 3 is a schematic representation of an exemplary embodiment of a ride reservation interface 300 suitable for use with a vehicle based transportation system. The interface 300 can be provided as a touch-sensitive screen on the user's mobile app, or it can be provided as GUI screen displayed on a monitor of a desktop computer system, e.g., as an online form rendered in a web browser application. This example assumes that the interface 300 is rendered on an electronic display of the passenger's mobile device, and that the passenger can interact with it using software buttons and/or UI elements.

FIG. 3 shows a simplified single-screen implementation of the interface 300. In practice, a ride request or reservation may require additional user input, multiple interface screens, or the like. FIG. 3 is simply intended to illustrate how certain user-specified options can be selected or input in a convenient manner when requesting a ride. The depicted embodiment of the ride reservation interface 300 includes the following fields, without limitation: a pick-up field 302; a destination field 304; a ride type field 306; a privacy setting field 308; and a profile sharing setting field 310. FIG. 3 also depicts a “catch-all” field 312 that is intended to represent other selectable options that might be available to the requesting passenger. The pick-up field 302 indicates the desired pick-up location and time (if applicable). As mentioned above, the pick-up location can be automatically set based on a GPS reading, or it can be manually selected or pinned by the user. The destination field 304 indicates at least one destination, and the content of the destination field 304 will usually be set by the user.

For this particular example, the remaining fields of the ride reservation interface 300 are depicted as selectable drop-down menus, wherein clicking on the downward pointing triangle reveals the selectable options for each field. Thus, the requesting user can select a desired ride type for the ride type field 306, a desired privacy level for the privacy setting field 308, a desired level for the profile sharing setting field 310, and (if applicable) other settings or levels for the other selectable options field 312. The different ride type, privacy, and profile sharing options were discussed in more detail above. After the user is satisfied with the content of the ride reservation interface 300, the request can be sent (i.e., communicated to a server system, a backend system, a dispatch center, etc.) by clicking on the “Request Ride” button 314.

Passenger Identity Verification

The following description assumes that the system 102 and/or the autonomous vehicle 104 has obtained or has access to the details of a ride request or reservation, such as a user identifier, payment options, sharing/privacy preferences, and the like. Thus, the system processes a ride request for a requesting passenger, dispatches an autonomous vehicle 104 to the pickup location for that passenger, or schedules a vehicle dispatch at the appropriate time (which may be needed for reservations made in advance). A passenger who is about to enter the vehicle 104 must identify himself to the system 102, for security reasons. Thus, new passengers cannot enter the vehicle 104 while it is in motion, or at any waypoint stop without having a prior reservation approved by the system 102 or the service provider. The autonomous vehicle 104 and/or the system 102 is suitably configured to confirm and verify that the person entering the vehicle 104 is actually the user who made the reservation. In this regard, an identity verification procedure can be performed after the vehicle 104 reaches the pickup location. Thus, passengers already in the vehicle 104 can be assured that verified and registered users are joining them. Passenger confirmation and verification can be carried out in a variety of different ways, using components onboard the vehicle 104, a suitable mobile app running on the passenger's user device 106, or the like. For example, after processing a reservation (a ride request), the system 102 or a mobile app can generate a verification or access code for the passenger. The verification code can be a single-use code that expires after a predetermined period of time. The verification code can be an alphanumeric string of any length, a numeric code having any number of digits, or the like. The autonomous vehicle 104 can have a keypad or a touchscreen element to obtain a user-entered code from the passenger. If an invalid code is entered, the autonomous vehicle 104 can initiate security measures to ensure that the person cannot enter the vehicle. As another example, the ride request can include a user identifier for the requesting passenger, and the identity verification procedure can obtain and compare an identifier from the passenger to check for a match. As another example, a biometric scanner can be installed on the autonomous vehicle 104 to verify the identity of a potential passenger using fingerprint data, eye scanner data, facial recognition data, voice recognition data, or the like. As yet another example, the system 102 can verify the identity of a potential passenger via a short range wireless communication protocol (such as the BLUETOOTH protocol) and a suitably configured security application running on the passenger's user device 106. In accordance with some embodiments, the autonomous vehicle 104 may include an onboard security badge reader, an RFID reader, a key fob receiver, or other verification component that can communicate with something owned or carried by the user for purposes of checking the identity of the user. Regardless of the verification mechanism, passenger access to the vehicle 104 is provided or granted only when the procedure verifies the identity of the requesting passenger. Conversely, the system 102 inhibits access to the vehicle 104 when the identity of the passenger is not verified.

Riding Passenger Notifications

The system 102 can provide notifications to passengers in transit to prepare them for approaching stops. In this regard, the system 102 controls the vehicle 104 to drive to a pickup location for a waiting passenger. The system 102 and/or the passenger's mobile device can monitor the progress of the vehicle 104 in transit. Before the vehicle 104 reaches the pickup location, the system 102 can provide a suitably formatted notification that is intended for a current passenger in the vehicle 104. The notification indicates that the vehicle 104 will be stopping at the pickup location. In some scenarios, the notification can include some of the user profile information of the waiting passenger (or passengers) about to be picked up, such as the passenger's username, social media handle, legal name, or any combination thereof. Whether or not such user profile information is provided may be controlled by the type of ride that has been reserved, the existing passenger's sharing/privacy settings, the new passenger's sharing/privacy settings, etc. These notifications can be provided on a display screen or any display element onboard the vehicle 104, annunciated by an audio system onboard the vehicle 104, provided on a display of a personal user device or a shared device, etc. In certain embodiments, the notifications can be sent as personal notifications to a mobile device owned, operated, or carried by the current passenger. For example, these notifications can be delivered to a mobile app running on the current passenger's smart phone.

Passenger Distress Button

In accordance with certain embodiments, the system 102 allows passengers to request assistance or generate an alert while the vehicle 104 is in transit. This feature may be referred to as a “panic button” feature, an “SOS” button feature, an “emergency alert” feature, or a “help” feature. If a passenger feels intimidated or threatened, or otherwise needs assistance, then he can take advantage of this feature. In practice, the vehicle 104 can include one or more passenger distress buttons, which may be implemented as physical hardware buttons, touchscreen buttons, a voice activated feature, or the like. For example, there can be one button provided at each passenger seat position. Alternatively or additionally, a mobile app (such as the ride reservation app) on the passenger's user device 106 can include a passenger distress button or icon that can be activated by the user as needed. Alternatively or additionally, a shared device in the vehicle 104, such as a tablet, a console, or other type of smart device can provide passenger access to the distress feature. The passenger distress feature may allow the user to indicate the level of distress/emergency (e.g., minor disturbance, serious threat, unsure), and/or allow the user to enter a description of the situation. In some embodiments, the distress message can be sent with an indication of the level or severity of the situation, as selected by the passenger. In this regard, the passenger can indicate whether the situation is associated with “low level of intimidation” to “very high danger” or any number of intermediate levels.

In response to the activation of the passenger distress feature during an automated ride, the system 102 receives a passenger distress message. Alternatively or additionally, activation of the passenger distress feature can independently notify: an emergency contact set by the passenger, such as a parent, a sibling, or a coworker; a hospital, doctor, the fire department, the police department, or any emergency response service, depending on the context or severity of the situation. The passenger distress message can be generated in response to activation of a hardware button onboard the vehicle 104, a hardware button of a user device 106, activation of a software button or a touchscreen of a user device 106, or the like. Thus, the system 102 can utilize a hardware button in the vehicle 104, a hardware button on a system onboard the vehicle 104, on a shared device, on a personal device, or on any type of smart device. The passenger distress feature could be activated by: a soft button, a voice command, a gesture command, a touch or a touch pattern, force or pressure (e.g., the user's weight on a seat), or the like. An agent (which can be a human operator or an artificially intelligent model) can process the passenger distress message to determine how best to resolve the issue. In other words, the system 102 can react by determining and initiating a suitable response action, such as commanding or controlling the vehicle 102 in an appropriate manner. Responsive actions can include any of the following, without limitation: stopping the autonomous vehicle; unlocking doors of the autonomous vehicle; sending a message to an emergency contact associated with the passenger; controlling the vehicle to drive to a police station; sending a message to a law enforcement agency, fire department, or other municipal organization; sending a message to a service provider, such as the command and control center of the system 102; initializing a security camera onboard the autonomous vehicle; initializing an audio recorder onboard the autonomous vehicle; controlling the vehicle to drive to a medical facility; generating an audible or visual alarm at the autonomous vehicle; activating or deactivating the vehicle lights (e.g., flashing the headlights or taillights, activating the hazard lights, etc.); changing the external color of the vehicle 104 or a portion thereof; emitting or changing the sound of the vehicle 104.

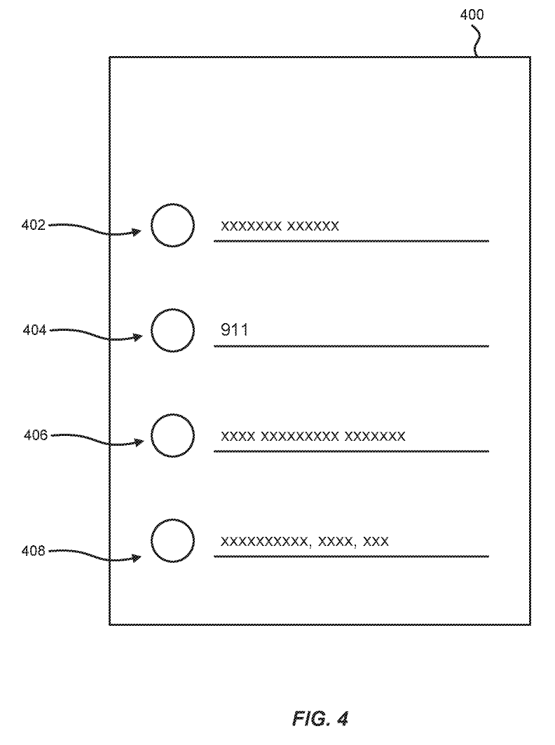

FIG. 4 is a schematic representation of an exemplary embodiment of an emergency assistance interface 400 suitable for use with a vehicle based transportation system of the type described here. As explained above, the emergency assistance interface 400 can be provided as a touch-sensitive screen on the user's mobile app, or it can be provided as a touch-sensitive screen on an onboard vehicle display. In certain embodiments, the emergency assistance interface 400 (or a portion thereof) can be implemented as one or more hardware buttons, switches, or devices onboard the vehicle to enable the passenger to request emergency assistance. This example assumes that the emergency assistance interface 400 is rendered on an electronic display, and that the passenger can interact with it using software buttons and/or UI elements.

The illustrated embodiment of the emergency assistance interface 400 includes four selectable items corresponding to different emergency contacts available to the passenger. Selection or activation of a first item 402 initiates contact with a service center, a call center, a dispatch center, a command center, or the like. Selection or activation of a second item 404 initiates contact with an emergency call service, e.g., 911 dispatch. Selection or activation of a third item 406 initiates contact with the user's emergency contact person (or more than one person if so configured). Selection or activation of a fourth item 408 initiates contact with a local paramedic, fire, or emergency medical technician service. Selection or activation of any of these items can initiate a phone call, a text message, an automatically generated distress message, or the like.

Passenger Ratings

For shared rides where passengers are either partially or fully identified to other passengers, the system 102 can collect, maintain, and process passenger ratings. Passenger ratings can be based on any number of factors, which may be subjective or objective. For example, any or all of the following passenger traits or characteristics can be rated: general behavior; loudness; friendliness; appearance; politeness; or the like. Passenger ratings can be created and submitted while the vehicle is in transit, or after completion of the ride. In certain embodiments, the system 102 only accepts passenger ratings for a limited time after completion of the ride, to ensure that accurate and timely ratings are processed. The system 102 can make passenger ratings publicly available to all registered users to help them make informed decisions regarding ride sharing. In this context, passenger rating can be used to “filter” the population of potential passengers when making a ride reservation. The passenger rating data can include or be expressed as a score, a ranking, or a grade for the user. Alternatively or additionally, the passenger rating data can include a description of the reviewed passenger's behavior, characteristics, traits, personality, habits, manners, etc. For example, a requesting passenger can indicate that she is only willing to share a ride with people who have at least a minimum number of passenger reviews that exceed a threshold score (such as 4 out of 5 stars, 7 or above on a scale of 10, or at least 75% “likes”). As another example, a user waiting to be picked up by a shared vehicle may choose to “Skip” or “Pass” and wait longer for another vehicle if the user notices that the current occupant of the shared vehicle has a low or undesirable passenger rating. As another example, the system 102 can be configured to send a notification to one or more people or entities (such as a parent) when a user makes a ride reservation that includes ride share passengers having a rating below a certain threshold.

In accordance with certain embodiments, each registered user of the system 102 has a respective passenger rating profile that is maintained and updated by the system 102. A shared ride can be identified for purposes of obtaining passenger reviews. The system 102 can receive passenger rating data from a reviewing passenger, wherein the passenger rating data applies to a reviewed passenger. Thereafter, the passenger rating profile of the reviewed passenger can be updated in response to the received passenger rating data. The rating system can be affected by or otherwise regulated by the sharing/privacy settings of the passengers. In this regard, if a passenger has opted to keep all of her profile information private, then it will be difficult if not impossible for other passengers to intelligently review that person.

It should be appreciated that the processing intelligence, control methodologies, and other functionality described above may reside at one or more of the components and systems of the operating environment 100. In certain implementations, for example, most of the processing intelligence is carried out by the various network-based systems, and the autonomous vehicles 104 and the user devices 106 play a secondary role. In other implementations, however, more of the processing load can be handled by the user devices 106 and/or by the computer-based systems onboard the autonomous vehicles 104. Moreover, although FIG. 1 depicts distinct blocks for the system 102, the security and access system 108, the user device 106, and the navigation and map system 110, the functionality of these systems can be combined and implemented in one or more hardware platforms. These and other hardware realizations are contemplated by this disclosure.

In accordance with certain embodiments, a method involves: processing a ride request for a passenger of an autonomous vehicle transportation system, the ride request comprising a ride type designation selected from the group comprising: solo ride, public ride, by invitation ride, social ride, and social friends ride; and providing passenger security, passenger safety, and/or passenger privacy features for the requested ride, wherein the provided features are determined based on the ride type designation. In accordance with an embodiment of this method, the provided features include at least one feature associated with control of an autonomous vehicle dispatched to service the ride request. In accordance with an embodiment of this method, the provided features include at least one feature associated with passenger screening for shared ride types. In accordance with an embodiment of this method, the passenger screening comprises processing user profile information for potential passengers. In accordance with an embodiment of this method, the provided features are determined based on user profile sharing/privacy settings associated with the passenger.

In accordance with certain embodiments, a computer-based system includes a memory element and a processor device communicatively coupled to the memory element, the memory element having computer executable instructions stored thereon and configurable to be executed by the processor to cause the computer-based system to: process a ride request for a passenger of an autonomous vehicle transportation system, the ride request comprising a ride type designation selected from the group comprising: solo ride, public ride, by invitation ride, social ride, and social friends ride; and provide passenger security, passenger safety, and/or passenger privacy features for the requested ride, wherein the provided features are determined based on the ride type designation. In accordance with an embodiment of this system, the provided features comprise at least one feature associated with control of an autonomous vehicle dispatched to service the ride request, or at least one feature associated with passenger screening for shared ride types. In accordance with an embodiment of this system, the passenger screening comprises processing user profile information for potential passengers. In accordance with an embodiment of this system, the provided features are determined based on user profile sharing/privacy settings associated with the passenger.

In accordance with certain embodiments, a mobile device includes a memory element and a processor device communicatively coupled to the memory element, the memory element having computer-executable instructions stored thereon and configurable to be executed by the processor to cause the mobile device to: create a ride request for a passenger of an autonomous vehicle transportation system, the ride request comprising a ride type designation selected from the group comprising: solo ride, public ride, by invitation ride, social ride, and social friends ride; and communicate the ride request to a server associated with the autonomous vehicle transportation system to provide passenger security, passenger safety, and/or passenger privacy features for the requested ride, wherein the provided features are determined based on the ride type designation.

In accordance with certain embodiments, a method involves: processing a ride request for a passenger of an autonomous vehicle transportation system; dispatching an autonomous vehicle to a pickup location for the passenger; performing an identity verification procedure for the passenger; and providing the passenger access to the autonomous vehicle only when the identity verification procedure verifies the identity of the passenger. In accordance with an embodiment, this method further involves: inhibiting access to the autonomous vehicle when the identity verification procedure does not verify the identity of the passenger. In accordance with an embodiment of this method, the ride request comprises a user identifier for the passenger, and the identity verification procedure obtains an identifier from the passenger and compares the obtained identifier against the user identifier. In accordance with an embodiment, this method further involves: providing an access code to the passenger in response to processing the ride request, wherein the identity verification procedure obtains a user-entered code from the passenger and compares the user-entered code against the access code. In accordance with an embodiment of this method, the identity verification procedure obtains biometric data from the passenger and compares the obtained biometric data against corresponding stored biometric data saved in association with a user profile of the passenger.

In accordance with certain embodiments, a computer-based system includes a memory element and a processor device communicatively coupled to the memory element, the memory element having computer executable instructions stored thereon and configurable to be executed by the processor to cause the computer-based system to: process a ride request for a passenger of an autonomous vehicle transportation system; dispatch an autonomous vehicle to a pickup location for the passenger; perform an identity verification procedure for the passenger; and provide the passenger access to the autonomous vehicle only when the identity verification procedure verifies the identity of the passenger. In accordance with an embodiment of this system, the computer-executable instructions are configurable to cause the computer-based system to: inhibit access to the autonomous vehicle when the identity verification procedure does not verify the identity of the passenger. In accordance with an embodiment of this system, the ride request comprises a user identifier for the passenger; and the identity verification procedure obtains an identifier from the passenger and compares the obtained identifier against the user identifier. In accordance with an embodiment of this system, the computer-executable instructions are configurable to cause the computer-based system to: provide an access code to the passenger in response to processing the ride request, wherein the identity verification procedure obtains a user-entered code from the passenger and compares the user-entered code against the access code. In accordance with an embodiment of this system, the identity verification procedure obtains biometric data from the passenger and compares the obtained biometric data against corresponding stored biometric data saved in association with a user profile of the passenger.

In accordance with certain embodiments, a vehicle includes a memory element and a processor device communicatively coupled to the memory element, the memory element having computer executable instructions stored thereon and configurable to be executed by the processor to cause the vehicle to: respond to a ride request for a passenger of an autonomous vehicle transportation system; travel to a pickup location for the passenger; perform an identity verification procedure for the passenger; and provide the passenger access to the vehicle only when the identity verification procedure verifies the identity of the passenger.

In accordance with certain embodiments, a method involves: controlling an autonomous vehicle to drive to a pickup location for a waiting passenger; and before the autonomous vehicle reaches the pickup location, providing a notification intended for a current passenger in the autonomous vehicle, the notification indicating that the autonomous vehicle will be stopping at the pickup location. In accordance with an embodiment, this method further involves generating the notification such that the notification identifies the waiting passenger by username, social media handle, legal name, or any combination thereof. In accordance with an embodiment, this method further involves generating the notification such that the notification identifies at least some user profile information of the waiting passenger. In accordance with an embodiment of this method, the notification is displayed on a display element onboard the autonomous vehicle. In accordance with an embodiment of this method, the notification is annunciated by an audio system onboard the autonomous vehicle. In accordance with an embodiment of this method, the notification is sent to a user device owned, operated, or carried by the current passenger, and/or is sent to a shared device onboard the autonomous vehicle.

In accordance with certain embodiments, a computer-based system includes a memory element and a processor device communicatively coupled to the memory element, the memory element having computer executable instructions stored thereon and configurable to be executed by the processor to cause the computer-based system to: control an autonomous vehicle to drive to a pickup location for a waiting passenger; and before the autonomous vehicle reaches the pickup location, provide a notification intended for a current passenger in the autonomous vehicle, the notification indicating that the autonomous vehicle will be stopping at the pickup location. In accordance with an embodiment of this system, the computer-executable instructions are configurable to cause the computer-based system to generate the notification such that the notification identifies the waiting passenger by username, social media handle, legal name, or any combination thereof. In accordance with an embodiment of this system, the computer-executable instructions are configurable to cause the computer-based system to generate the notification such that the notification identifies at least some user profile information of the waiting passenger. In accordance with an embodiment of this system, the notification is displayed on a display element onboard the autonomous vehicle. In accordance with an embodiment of this system, the notification is annunciated by an audio system onboard the autonomous vehicle. In accordance with an embodiment of this system, the notification is sent to a user device owned, operated, or carried by the current passenger, and/or is sent to a shared device onboard the autonomous vehicle.

In accordance with certain embodiments, a vehicle includes a memory element and a processor device communicatively coupled to the memory element, the memory element having computer executable instructions stored thereon and configurable to be executed by the processor to cause the vehicle to: autonomously drive to a pickup location for a waiting passenger; and before the vehicle reaches the pickup location, provide a notification intended for a current passenger in the vehicle, the notification indicating that the vehicle will be stopping at the pickup location.

In accordance with certain embodiments, a mobile device includes a memory element and a processor device communicatively coupled to the memory element, the memory element having computer executable instructions stored thereon and configurable to be executed by the processor to cause the mobile device to: monitor progress of a vehicle in transit to a pickup location for a waiting passenger; and before the vehicle reaches the pickup location, provide a notification intended for a current passenger in the vehicle, the notification indicating that the vehicle will be stopping at the pickup location.

In accordance with certain embodiments, a method involves: controlling an autonomous vehicle to transport a passenger during an automated ride; during the automated ride, receiving a passenger distress message, the passenger initiating the generation of the passenger distress message; processing the passenger distress message to determine a response action; and initiating the response action. In accordance with an embodiment, this method further involves generating the passenger distress message in response to activation of a hardware button onboard the autonomous vehicle. In accordance with an embodiment, this method further involves generating the passenger distress message in response to activation of a hardware button of a user device owned, operated, or carried by the passenger, and/or in response to activation of a hardware button of a shared device onboard the autonomous vehicle. In accordance with an embodiment, this method further involves generating the passenger distress message in response to activation of a software button or touchscreen of a user device owned, operated, or carried by the passenger, and/or in response to activation of a software button or touchscreen of a shared device onboard the autonomous vehicle. In accordance with an embodiment of this method, the response action comprises one or more of the following: stopping the autonomous vehicle; unlocking doors of the autonomous vehicle; sending a message to an emergency contact associated with the passenger; controlling the vehicle to drive to a police station; sending a message to a law enforcement agency; sending a message to a service provider; initializing a security camera onboard the autonomous vehicle; initializing an audio recorder onboard the autonomous vehicle; controlling the vehicle to drive to a medical facility; generating an audible or visual alarm at the autonomous vehicle.

In accordance with certain embodiments, a computer-based system includes a memory element and a processor device communicatively coupled to the memory element, the memory element having computer executable instructions stored thereon and configurable to be executed by the processor to cause the computer-based system to: control an autonomous vehicle to transport a passenger during an automated ride; during the automated ride, receive a passenger distress message, the passenger initiating the generation of the passenger distress message; process the passenger distress message to determine a response action; and initiate the response action. In accordance with an embodiment of this system, the computer-executable instructions are configurable to cause the computer-based system to generate the passenger distress message in response to activation of a hardware button onboard the autonomous vehicle. In accordance with an embodiment of this system, the computer-executable instructions are configurable to cause the computer-based system to generate the passenger distress message in response to activation of a hardware button of a user device owned, operated, or carried by the passenger, and/or in response to activation of a hardware button of a shared device onboard the autonomous vehicle. In accordance with an embodiment of this system, the computer-executable instructions are configurable to cause the computer-based system to generate the passenger distress message in response to activation of a software button or touchscreen of a user device owned, operated, or carried by the passenger, and/or in response to activation of a software button or touchscreen of a shared device onboard the autonomous vehicle. In accordance with an embodiment of this system, the response action comprises one or more of the following: stopping the autonomous vehicle; unlocking doors of the autonomous vehicle; sending a message to an emergency contact associated with the passenger; controlling the vehicle to drive to a police station; sending a message to a law enforcement agency; sending a message to a service provider; initializing a security camera onboard the autonomous vehicle; initializing an audio recorder onboard the autonomous vehicle; controlling the vehicle to drive to a medical facility; generating an audible or visual alarm at the autonomous vehicle.

In accordance with certain embodiments, a vehicle includes a memory element and a processor device communicatively coupled to the memory element, the memory element having computer executable instructions stored thereon and configurable to be executed by the processor to cause the vehicle to: operate autonomously to transport a passenger during an automated ride; during the automated ride, receive a passenger distress message, the passenger initiating the generation of the passenger distress message; process the passenger distress message to determine a response action; and initiate the response action.

In accordance with certain embodiments, a mobile device includes a memory element and a processor device communicatively coupled to the memory element, the memory element having computer executable instructions stored thereon and configurable to be executed by the processor to cause the mobile device to: monitor progress of a vehicle transporting a passenger during an automated ride; during the automated ride, receive a passenger distress message, the passenger initiating the generation of the passenger distress message; process the passenger distress message to determine a response action; and initiate the response action.

In accordance with certain embodiments, a method involves: maintaining a list of registered users of an autonomous vehicle transportation system, each of the registered users having a respective passenger rating profile; identifying a shared ride that includes a plurality of passengers, wherein each of the passengers is a registered user of the transportation system; receiving, from a reviewing one of the passengers, passenger rating data for a reviewed one of the passengers; and updating the passenger rating profile of the reviewed passenger in response to the passenger rating data. In accordance with an embodiment of this method, the receiving is regulated by sharing/privacy settings of the passengers. In accordance with an embodiment, this method further involves: allowing any registered user of the autonomous vehicle transportation system to gain access to the passenger rating profiles. In accordance with an embodiment of this method, the passenger rating data comprises a score, a ranking, or a grade for the reviewed passenger. In accordance with an embodiment of this method, the passenger rating data comprises a description of the reviewed passenger's behavior, characteristics, traits, personality, habits, and/or manners.

In accordance with certain embodiments, a computer-based system includes a memory element and a processor device communicatively coupled to the memory element, the memory element having computer executable instructions stored thereon and configurable to be executed by the processor to cause the computer-based system to: maintain a list of registered users of an autonomous vehicle transportation system, each of the registered users having a respective passenger rating profile; identify a shared ride that includes a plurality of passengers, wherein each of the passengers is a registered user of the transportation system; receive, from a reviewing one of the passengers, passenger rating data for a reviewed one of the passengers; and update the passenger rating profile of the reviewed passenger in response to the passenger rating data. In accordance with an embodiment of this system, the receiving is regulated by sharing/privacy settings of the passengers. In accordance with an embodiment of this system, the computer-executable instructions are configurable to cause the computer-based system to allow any registered user of the autonomous vehicle transportation system to gain access to the passenger rating profiles. In accordance with an embodiment of this system, the passenger rating data comprises a score, a ranking, or a grade for the reviewed passenger. In accordance with an embodiment of this system, the passenger rating data comprises a description of the reviewed passenger's behavior, characteristics, traits, personality, habits, manners, etc.

In accordance with certain embodiments, a vehicle includes a memory element and a processor device communicatively coupled to the memory element, the memory element having computer executable instructions stored thereon and configurable to be executed by the processor to cause the vehicle to: maintain a list of registered users of an autonomous vehicle transportation system, each of the registered users having a respective passenger rating profile; identify a shared ride that includes a plurality of passengers, wherein each of the passengers is a registered user of the transportation system; receive, from a reviewing one of the passengers, passenger rating data for a reviewed one of the passengers; and update the passenger rating profile of the reviewed passenger in response to the passenger rating data.

In accordance with certain embodiments, a mobile device includes a memory element and a processor device communicatively coupled to the memory element, the memory element having computer executable instructions stored thereon and configurable to be executed by the processor to cause the mobile device to: maintain a list of registered users of an autonomous vehicle transportation system, each of the registered users having a respective passenger rating profile; identify a shared ride that includes a plurality of passengers, wherein each of the passengers is a registered user of the transportation system; receive, from a reviewing one of the passengers, passenger rating data for a reviewed one of the passengers; and update the passenger rating profile of the reviewed passenger in response to the passenger rating data.

In accordance with certain embodiments, a computer-readable medium includes processor-executable instructions configurable to be executed by a processor to perform any of the methods described in detail herein, summarized above, or claimed herein.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-based system comprising a memory element and a processor device communicatively coupled to the memory element, the memory element having computer-executable instructions stored thereon and configurable to be executed by the processor to cause the computer-based system to:
process a ride request for a passenger of an autonomous vehicle transportation system, the ride request comprising a ride type designation selected from a group comprising: solo ride, public ride, by invitation ride, social ride, and social friends ride; and
provide at least one of passenger security, passenger safety, and passenger privacy features for the requested ride, wherein the provided features are determined based on the ride type designation.

2. The computer-based system of claim 1, wherein the provided features comprise at least one feature associated with control of an autonomous vehicle dispatched to service the ride request, or at least one feature associated with passenger screening for shared ride types.

3. The computer-based system of claim 2, wherein the passenger screening comprises processing user profile information for potential passengers.

4. The computer-based system of claim 1, wherein the provided features are determined based on user profile sharing/privacy settings associated with the passenger.

5. A computer-based system comprising a memory element and a processor device communicatively coupled to the memory element, the memory element having computer-executable instructions stored thereon and configurable to be executed by the processor to cause the computer-based system to:
process a ride request for a passenger of an autonomous vehicle transportation system;
dispatch an autonomous vehicle to a pickup location for the passenger;
perform an identity verification procedure for the passenger; and
provide the passenger access to the autonomous vehicle only when the identity verification procedure verifies the identity of the passenger.

6. The computer-based system of claim 5, wherein the computer-executable instructions are configurable to cause the computer-based system to:
inhibit access to the autonomous vehicle when the identity verification procedure does not verify the identity of the passenger.

7. The computer-based system of claim 5, wherein:
the ride request comprises a user identifier for the passenger; and
the identity verification procedure obtains an identifier from the passenger and compares the obtained identifier against the user identifier.

8. The computer-based system of claim 5, wherein the computer-executable instructions are configurable to cause the computer-based system to:
provide an access code to the passenger in response to processing the ride request, wherein the identity verification procedure obtains a user-entered code from the passenger and compares the user-entered code against the access code.

9. The computer-based system of claim 5, wherein the identity verification procedure obtains biometric data from the passenger and compares the obtained biometric data against corresponding stored biometric data saved in association with a user profile of the passenger.

10. The computer-based system of claim 5, wherein the computer-executable instructions are configurable to cause the computer-based system to:
maintain a list of registered users of the autonomous vehicle transportation system, each of the registered users having a respective passenger rating profile;
identify a shared ride that includes a plurality of passengers, wherein each of the passengers is a registered user of the transportation system;
receive, from a reviewing one of the passengers, passenger rating data for a reviewed one of the passengers; and
update the passenger rating profile of the reviewed passenger in response to the passenger rating data.

11. The computer-based system of claim 10, wherein the computer-executable instructions are configurable to cause the computer-based system to allow any registered user of the autonomous vehicle transportation system to gain access to the passenger rating profiles.

12. The computer-based system of claim 10, wherein the passenger rating data comprises a description of the reviewed passenger's behavior, characteristics, traits, personality, habits, manners, etc.

13. The computer-based system of claim 5, wherein the computer-executable instructions are configurable to cause the computer-based system to:
control the autonomous vehicle to transport a passenger during an automated ride;
during the automated ride, receive a passenger distress message, the passenger initiating the generation of the passenger distress message;
process the passenger distress message to determine a response action; and
initiate the response action.

14. The computer-based system of claim 13, wherein the computer-executable instructions are configurable to cause the computer-based system to generate the passenger distress message in response to activation of at least one of: a user input at a user device associated with the passenger, and a software button at a shared device onboard the autonomous vehicle.

15. The computer-based system of claim 13, wherein the response action includes at least one of the following: stopping the autonomous vehicle; unlocking doors of the autonomous vehicle; sending a message to an emergency contact associated with the passenger; controlling the vehicle to drive to a police station; sending a message to a law enforcement agency; sending a message to a service provider; initializing a security camera onboard the autonomous vehicle; initializing an audio recorder onboard the autonomous vehicle; controlling the vehicle to drive to a medical facility; generating an audible or visual alarm at the autonomous vehicle.

16. A computer-based system comprising a memory element and a processor device communicatively coupled to the memory element, the memory element having computer-executable instructions stored thereon and configurable to be executed by the processor to cause the computer-based system to:
control an autonomous vehicle to drive to a pickup location for a waiting passenger; and
before the autonomous vehicle reaches the pickup location, provide a notification intended for a current passenger in the autonomous vehicle, the notification indicating that the autonomous vehicle will be stopping at the pickup location.

17. The computer-based system of claim 16, wherein the computer-executable instructions are configurable to cause the computer-based system to generate the notification such that the notification identifies the waiting passenger by at least one of: username, social media handle, and legal name.

18. The computer-based system of claim 16, wherein the computer-executable instructions are configurable to cause the computer-based system to generate the notification such that the notification identifies at least some user profile information of the waiting passenger.

19. The computer-based system of claim 16, wherein the notification is provided via at least one of: a display element onboard the autonomous vehicle, and an audio system onboard the autonomous vehicle.

20. The computer-based system of claim 16, wherein the notification is sent to at least one of: a user device associated with the current passenger, and a shared device onboard the autonomous vehicle.
